(19) United States
(12) Patent Application Publication
(10) Pub. No.: US 2026/0111934 A1
(43) Pub. Date: Apr. 23, 2026

(54) SERVER AND METHOD FOR PROCESSING CONSUMER REVIEWS

(71) Applicant: Grabtaxi Holdings Pte. Ltd., Singapore (SG)

(72) Inventors: Saiya JIANG, Singapore (SG); Yongjian SUI, Singapore (SG); Huijing CAI, Singapore (SG)

(21) Appl. No.: 19/117,644

(22) PCT Filed: Oct. 5, 2023
(86) PCT No.: PCT/SG2023/050676

§ 371 Date: Apr. 2, 2025

(30) Foreign Application Priority Data
Oct. 19, 2022 (SG) 10202251420U

(51) Int. Cl. G06Q 30/0282; G06Q 30/0601

(52) U.S. Cl. CPC G06Q 30/0282; G06Q 30/0643

(57) ABSTRACT

Aspects concern a server for processing consumer reviews, the server configured to: access the consumer reviews associated with a service provider; select at least one of the consumer reviews which is relevant to at least one predetermined category; obtain an annotation associated with the selected consumer review from a computing device associated with a third party; generate a tag content associated with the selected consumer review by summarizing the selected consumer review; and generate a tag associated with the selected consumer review based on the tag content and the annotation associated with the selected consumer review, wherein the processor is further configured to classify the selected consumer review based on at least one property of the selected consumer review, and distribute a task for the annotation associated with the selected consumer review to the computing device associated with the third party based on the classification of the selected consumer review.

### TECHNICAL FIELD

Various embodiments relate to a server and a method for processing consumer reviews.

### BACKGROUND

Due to development of information and communications technology, a consumer may request an on-demand service using a computing device. The on-demand service may allow the consumer to fulfil the consumer's demand via an immediate access to items and/or services provided by service providers. The consumer may request the on-demand service, for example, a food delivery service, using a user interface screen presented on the computing device.

Consumers may tend to select more familiar service providers in requesting the on-demand service. Therefore, service providers having long-tail strategies may face challenges to acquire new consumers. Due to low popularity and awareness of the service providers having the long-tail strategies, the service providers having the long-tail strategies may be less likely to be matched with search keywords input by the consumers and less likely to be displayed at high rank of a searched list of service providers.

Meanwhile, conventionally, a platform for providing the on-demand service may use user-generated contents (UGC) (hereinafter, referred to as “consumer reviews”) associated with the service providers, which were previously generated by the consumers, so as to increase credibility and social proof for the service providers.

FIG. 1 illustrates exemplary user interface screens 160a, 160b, 160c of a computing device 160 associated with a user 161 (also referred to as a “consumer”) according to conventional technologies. As shown in FIG. 1, the computing device 160 of the user 161 may display a user interface screen 160a for the user 161 to make the request for on-demand service. The computing device 160 may display a list of service providers 191. Information about the service providers may be displayed on service provider cards (also referred to as “merchant cards”) 191a, 191b, 191c in the list of service providers 191. For example, each service provider card 191a, 191b, 191c may show at least one of promotion information, a type of the service provider, performance of the service provider, an estimated time of arrival (“ETA”), ratings, and information about items provided by the service provider. If the user 161 selects one of the service provider cards 191a, 191b, 191c, for example, a first service provider card 191a, the computing device 160 may display a user interface screen 160b showing detailed information about the selected service provider and items provided by the selected service provider. If the user selects an icon for “see details” 192, the computing device 160 may display a user interface screen 160c showing consumer reviews 193 associated with the selected service provider.

However, according to the conventional technologies, the user 161 may only view the consumer reviews 193 associated with a certain service provider, for example, the first service provider, after selecting the first service provider card 191a from the list of the service providers 191. If the user 161 is not familiar with the first service provider, the user 161 may be less likely to select the first service provider card 191a to view the consumer reviews 193 associated with the first service provider. In addition, some consumer reviews 193, for example, a first consumer review 193a, may be lengthy and require the user's 161 efforts to read through. Sometimes, consumer reviews 193 which are not relevant to the first service provider, for example, a second consumer review 193b which is relevant to a delivery service, may be shown to the user 161.

Moreover, consumers may be likely to leave negative consumer reviews associated with the service provider when the consumers have bad experiences, and such negative consumer reviews may lead to a biased first impression about the service provider. In this case, the service provider may have to ask the platform to remove the negative consumer reviews while it may be already shown and cause some negative impact.

Accordingly, there exists a need for providing an improved solution for processing the consumer reviews.

### SUMMARY

According to various embodiments, there is a server for processing consumer reviews, the server comprising: a memory for storing instructions; and a processor for executing the stored instructions and configured to: access the consumer reviews associated with a service provider; select at least one of the consumer reviews which is relevant to at least one predetermined category; obtain an annotation associated with the selected consumer review from a computing device associated with a third party; generate a tag content associated with the selected consumer review by summarizing the selected consumer review; and generate a tag associated with the selected consumer review based on the tag content and the annotation associated with the selected consumer review, wherein the processor is further configured to classify the selected consumer review based on at least one property of the selected consumer review, and distribute a task for the annotation associated with the selected consumer review to the computing device associated with the third party based on the classification of the selected consumer review.

In some embodiments, the processor is further configured to update a rule for selecting the at least one of the consumer reviews which is relevant to the at least one predetermined category, based on the annotation obtained from the computing device associated with the third party.

In some embodiments, the processor is configured to generate the tag content associated with the selected consumer review based on at least one constraint stored in a tag configuration cache.

In some embodiments, the processor is further configured to check if the tag content satisfies with the at least one constraint stored in the tag configuration cache, and generate the tag associated with the selected consumer review if the tag content satisfies with the at least one constraint.

In some embodiments, the processor is configured to generate the tag associated with the selected consumer review further based on search keywords input by a plurality of consumers.

In some embodiments, the processor is further configured to determine that the selected consumer review is relevant to two or more categories, and extract two or more phrases each relevant to the two or more categories from the selected consumer review using a natural language processing model.

In some embodiments, the processor is further configured to generate two or more tag contents each associated with the two or more phrases.

In some embodiments, the processor is further configured to display the tag associated with the selected consumer review along with information about the service provider included in a list of service providers.

In some embodiments, the processor is further configured to monitor a user's behaviour for tags displayed on a computing device associated with the user and/or at least one consumer review previously made by the user, and determine which tag of a plurality of tags is to be displayed on the computing device associated with the user based on the monitored information.

In some embodiments, the processor is further configured to determine a weight for each of the plurality of tag, based on the monitored information.

According to various embodiments, there is a method for processing consumer reviews, the method comprising: accessing the consumer reviews associated with a service provider; selecting at least one of the consumer reviews which is relevant to at least one predetermined category; classifying the selected consumer review based on at least one property of the selected consumer review; distributing a task for an annotation associated with the selected consumer review to a computing device associated with a third party based on the classification of the selected consumer review; obtaining the annotation associated with the selected consumer review from the computing device associated with the third party; generating a tag content associated with the selected consumer review by summarizing the selected consumer review; and generating a tag associated with the selected consumer review based on the tag content and the annotation associated with the selected consumer review.

In some embodiments, the method further comprises: updating a rule for selecting the at least one of the consumer reviews which is relevant to the at least one predetermined category, based on the annotation obtained from the computing device associated with the third party.

In some embodiments, the generating the tag content associated with the selected consumer review is based on at least one constraint stored in a tag configuration cache.

In some embodiments, the method further comprises: checking if the tag content satisfies with the at least one constraint stored in the tag configuration cache; and generating the tag associated with the selected consumer review if the tag content satisfies with the at least one constraint.

In some embodiments, the generating the tag associated with the selected consumer review is further based on search keywords input by a plurality of consumers.

In some embodiments, the method further comprises: determining that the selected consumer review is relevant to two or more categories; and extracting two or more phrases each relevant to the two or more categories from the selected consumer review using a natural language processing model.

In some embodiments, the method further comprises: generating two or more tag contents each associated with the two or more phrases.

In some embodiments, the method further comprises: displaying the tag associated with the selected consumer review along with information about the service provider included in a list of service providers.

In some embodiments, the method further comprises: monitoring a user's behaviour for tags displayed on a computing device associated with the user and/or at least one consumer review previously made by the user; and determining which tag of a plurality of tags is to be displayed on the computing device associated with the user based on the monitored information.

In some embodiments, the method further comprises: determining a weight for each of the plurality of tag, based on the monitored information.

According to various embodiments, a data processing apparatus configured to perform the method of any one of the above embodiments is provided.

According to various embodiments, a computer program element comprising program instructions, which, when executed by one or more processors, cause the one or more processors to perform the method of any one of the above embodiments is provided.

According to various embodiments, a computer-readable medium comprising program instructions, which, when executed by one or more processors, cause the one or more processors to perform the method of any one of the above embodiments is provided. The computer-readable medium may include a non-transitory computer-readable medium.

### BRIEF DESCRIPTION OF THE DRAWINGS

The invention will be better understood with reference to the detailed description when considered in conjunction with the non-limiting examples and the accompanying drawings, in which:

FIG. 1 illustrates exemplary user interface screens of a computing device associated with a user according to conventional technologies.

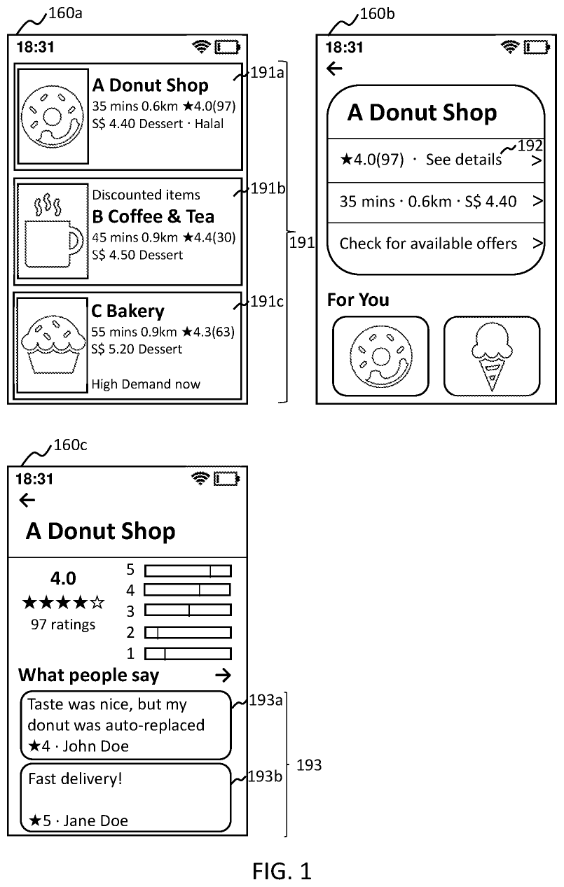

FIG. 2 illustrates an infrastructure of a system including a server for processing consumer reviews according to various embodiments.

FIG. 3 illustrates a block diagram of a server for processing consumer reviews according to various embodiments.

FIG. 4 illustrates a flow diagram for a method for processing consumer reviews according to various embodiments.

FIG. 5 illustrates an exemplary user interface screen of a computing device associated with a user according to various embodiments.

FIG. 6 illustrates an exemplary user interface screen of a computing device associated with a user according to various embodiments.

FIG. 7 illustrates a block diagram of a system for processing consumer reviews according to various embodiments.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized, and structural and logical changes may be made without departing from the scope of the disclosure. The various embodiments are not necessarily mutually exclusive, as some embodiments can be combined with one or more other embodiments to form new embodiments.

Embodiments described in the context of one of a server and a method are analogously valid for the other of the server and method. Similarly, embodiments described in the context of a server are analogously valid for a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

In the following, embodiments will be described in detail.

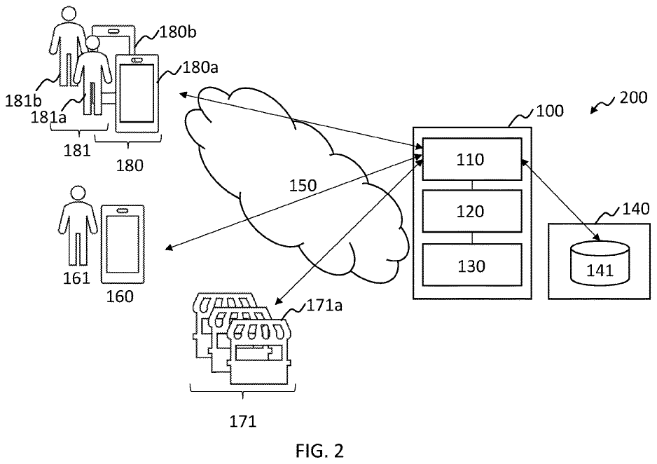

FIG. 2 illustrates an infrastructure of a system 200 including a server 100 for processing consumer reviews according to various embodiments.

As shown in FIG. 2, the system 200 may include, but is not limited to, the server 100, a database system 140, a network 150, and one or more external devices 170 (not shown) associated with one or more service providers 171. In some embodiments, the system 200 may further include a computing device 160 associated with a user 161. In some embodiments, the system 200 may further include one or more computing devices 180 associated with one or more third parties 181.

In some embodiments, an on-demand service may be a service allowing the user 161 to fulfil the user's 161 demand via an immediate access to items and/or services provided by the service providers 171. The user 161 may request the on-demand service, such as an item delivery service (for example, a food delivery service), using a user interface screen presented on the computing device 160.

In some embodiments, the network 150 may include, but is not limited to, a Local Area Network (LAN), a Wide Area Network (WAN), a Global Area Network (GAN), or any combination thereof. The network 150 may provide a wireline communication, a wireless communication, or a combination of the wireline and wireless communication between the server 100 and the computing device 160, between the server 100 and the one or more external devices 170, for example, one or more service provider devices 170, and between the server 100 and the one or more computing devices 180.

In some embodiments, the computing device 160 may be connectable to the server 100 via the network 150. In some embodiments, the computing device 160 may be arranged in data or signal communication with the server 100 via the network 150. In some embodiments, the computing device 160 may include, but is not limited to, at least one of the following: a mobile phone, a tablet computer, a laptop computer, a desktop computer, a head-mounted display and a smart watch. In some embodiments, the computing device 160 may be associated with the user 161. For example, the computing device 160 may belong to the user 161. Although not shown, in some embodiments, the system 200 may further include a plurality of computing devices each belonging to a plurality of users. In some embodiments, the user 161 may be a consumer. For example, the user 161 may leave a consumer review associated with the service provider on a platform operated by the server 100 and providing the on-demand service.

In some embodiments, the one or more computing devices 180 may be connectable to the server 100 via the network 150. In some embodiments, the one or more computing devices 180 may be arranged in data or signal communication with the server 100 via the network 150. In some embodiments, the one or more computing devices 180 may include, but is not limited to, at least one of the following: a mobile phone, a tablet computer, a laptop computer, a desktop computer, a head-mounted display and a smart watch. In some embodiments, the one or more computing devices 180 may be associated with the one or more third parties 181 respectively. For example, the each of the one or more computing devices 180 may belong to each of the one or more third parties 181 respectively. Although not shown, in some embodiments, the one or more third parties 181 may be consumers. In some other embodiments, the one or more third parties 181 may not be the consumers. In some other embodiments, a part of the one or more third parties 181 may be the consumers and the other part of the one or more third parties 181 may not be the consumers. In some embodiments, the one or more third parties 181 may use a predetermined software application, for example, a messaging program (e.g. a Slack application), installed in the one or more computing devices 180.

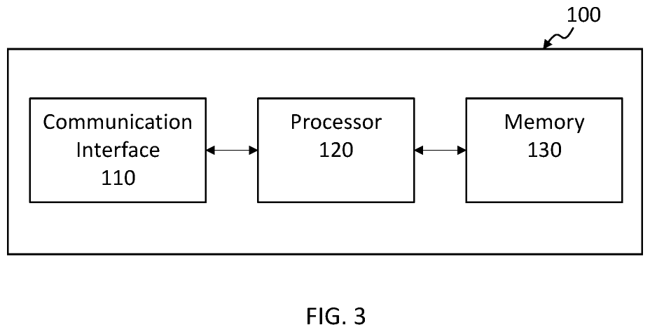

In some embodiments, the server 100, for example, implemented by a server computer, may include a communication interface 110, a processor 120, and a memory 130 (as will be described with reference to FIG. 3).

In some embodiments, the system 200 may further include a database 141. In some embodiments, the database 141 may be a part of the database system 140 which may be external to the server 100. The server 100 may communicate with the database 141. In some other embodiments, although not shown, the database 141 may be implemented locally in the memory 130 of the server 100.

In some embodiments, the consumers who used the on-demand service may leave consumer reviews associated with the service providers 171 on the platform providing the on-demand service. For example, the consumers (which may include the user 161) may leave the consumer reviews associated with a first service provider 171a after ordering food and receiving the food from the first service provider 171a. As an example, the consumers may leave the consumer reviews relevant to the first service provider 171a, for example, price, taste, safety, packaging and/or service of the first service provider 171a. As another example, the consumers may leave the consumer reviews which are not relevant to the first service provider 171a. For example, the consumer reviews may be relevant to a delivery service for delivering the food provided by the first service provider 171a. As another example, the consumers may leave the consumer reviews which include both contents relevant to the first service provider 171a and contents non-relevant to the first service provider 171a. The consumers may type the consumer reviews using his/her computing devices. In some embodiments, the server 100 operating the platform may encourage the consumers who ordered the food and received the food to leave the consumer reviews. For example, once the delivery of the food provided by the first service provider 171a is completed, the server 100 operating the platform may control the computing devices of the consumers to display a pop-up window so that the consumers can easily leave the consumer reviews associated with the first service provider 171a.

In some embodiments, the consumer reviews which were previously left by the consumers may be stored in the memory 130 of the server 100 and/or in the database 141 of the database system 140. In some other embodiments, the consumer reviews may be stored in an external database (not shown) and the communication interface 110 of the server 100 may access the external database.

In some embodiments, the server 100 may access the consumer reviews associated with service providers 171 and process the consumer reviews (as will be described with reference to FIG. 3).

FIG. 3 illustrates a block diagram of a server 100 for processing consumer reviews according to various embodiments.

As shown in FIG. 3, the server 100, for example, implemented by a server computer, may include a communication interface 110, a processor 120, and a memory 130.

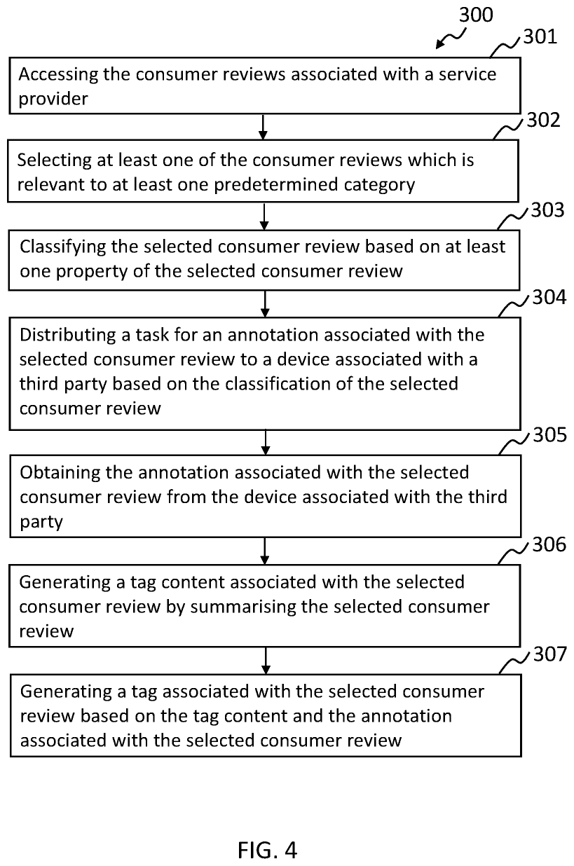

In some embodiments, the memory 130 (also referred to as a “database”) may store input data and/or output data temporarily or permanently. In some embodiments, the memory 130 may store program code which allows the server 100 to perform a method 300 (as will be described with reference to FIG. 4). In some embodiments, the program code may be embedded in a Software Development Kit (SDK). The memory 130 may include an internal memory of the server 100 and/or an external memory. The external memory may include, but is not limited to, an external storage medium, for example, a memory card, a flash drive, and a web storage.

In some embodiments, the communication interface 110 may allow one or more computing devices, including a computing device 160 and one or more computing devices 180, to communicate with the processor 120 of the server 100 via a network 150, as shown in FIG. 2. In some embodiments, as shown in FIG. 2, the computing device 160 may belong to a user 161 who wants to request an on-demand service, and the one or more computing devices 180 may belong to one or more third parties 181 who provide annotations (also referred to as “labels”) to the consumer reviews. In some embodiments, the communication interface 110 may transmit signals to the computing device 160 and the one or more computing devices 180, and/or receive signals from the computing device 160 and the one or more computing devices 180 via the network 150.

In some embodiments, the communication interface 110 may allow one or more external devices 170, for example, one or more service provider devices 170, to communicate with the processor 120 of the server 100 via the network 150, as shown in FIG. 2. In some embodiments, the communication interface 110 may transmit signals to the one or more external devices 170 and/or receive signals from the one or more external devices 170 via the network 150.

In some embodiments, the processor 120 may include, but is not limited to, a microprocessor, an analogue circuit, a digital circuit, a mixed-signal circuit, a logic circuit, an integrated circuit, a Central Processing Unit (CPU), a Graphics Processing Unit (GPU), a Digital Signal Processor (DSP), a Field Programmable Gate Array (FPGA), an Application Specific Integrated Circuit (ASIC), or any combination thereof. Any other kind of implementation of the respective functions, which will be described below in further detail, may also be understood as the processor 120.

In some embodiments, the processor 120 may access the consumer reviews associated with service providers 171, for example, a first service provider 171a. In some embodiments, the processor 120 may access the memory 130 of the server 100 and/or the database 141 of the database system 140 via the communication interface 110, to access the consumer reviews. For example, the processor 120 may obtain the consumer reviews stored in the memory 130 of the server 100 and/or the database 141 of the database system 140 via the communication interface 110. In some other embodiments, the processor 120 may access the external database storing the consumer reviews via the communication interface 110. For example, the processor 120 may obtain the consumer reviews stored in the external database via the communication interface 110. In some embodiments, the processor 120 may access at least a part of the consumer reviews stored in the memory 130 of the server 100, the database 141 of the database system 140 via the communication interface 110, and/or the external database via the communication interface 110. As an example, the processor 120 may decide which consumer reviews the processor 120 would access and/or obtain, for example, based on date of which the consumer reviews were left.

In some embodiments, after accessing the consumer reviews, the processor 120 may select at least one of the consumer reviews which is relevant to at least one predetermined category. In some embodiments, the processor 120 may include a natural language processing engine configured to analyze the consumer reviews and select the at least one of the consumer reviews based on the relevance to the at least one predetermined category. As described above, in some embodiments, the consumer reviews associated with the first service provider 171a may be relevant to the first service provider 171a, for example, price, taste, safety, packaging and/or service of the first service provider 171a. In some other embodiments, the consumer reviews associated with the first service provider 171a may be partially relevant to the first service provider 171a. In some other embodiments, the consumer reviews associated with the first service provider 171a may not be relevant to the first service provider 171a.

In some embodiments, the processor 120 may pre-determine at least one category which is relevant to the service provider. For example, the predetermined category may include, but is not limited to, price, taste, safety, packaging and/or service of the service provider. It may be appreciated that, in some embodiments, the predetermined category may be updated based on the processor 120 and/or an input from an operator of the platform. In some embodiments, the processor 120 may analyze the consumer reviews using the natural language processing engine, determine if each of the consumer reviews is relevant to the at least one predetermined category, and select the at least one of the consumer reviews which is relevant to the at least one predetermined category. For example, if a first consumer review states “I was very satisfied with the taste of the food”, the processor 120 may select the first consumer review which is relevant to a category of “taste”. As another example, if a second consumer review states “the delivery driver was kind”, the processor 120 may not select the second consumer review which is not relevant to any one of the predetermined categories. As another example, if a third consumer review states “I was very satisfied with the taste of the food and the kindness of the delivery driver”, the processor 120 may select the third consumer review which is relevant to the category of “taste”. As another example, if a fourth consumer review states “I was very satisfied with the taste of the food and the reasonable price”, the processor 120 may select the fourth consumer review which is relevant to the category of “taste” and a category of “price”. In this manner, consumer reviews which are not relevant to the service provider may be filtered out.

In some embodiments, the processor 120 may classify the selected consumer review based on at least one property of the selected consumer review, and distribute a task for the annotation associated with the selected consumer review to at least one of the one or more computing devices 180 associated with the one or more third parties 181 based on the classification of the selected consumer review.

In some embodiments, the one or more third parties 181 may use a predetermined software application, for example, a messaging program (e.g. a Slack application), installed in the one or more computing devices 180. A server (not shown) operating the predetermined software application may receive the task for the annotation from the processor 120, receive the annotation from the one or more third parties 181, and send the annotation to the processor 120.

In some embodiments, the processor 120 may classify the selected consumer review based on at least one property of metadata of the selected consumer review. In some embodiments, the processor 120 may apply high-level classifications on the at least one property, to the selected consumer review. In some embodiments, the at least one property may include, but is not limited to, a business vertical, a topic, and a language. For example, if the first consumer review states “I was very satisfied with the taste of the food” in English and the first consumer review is associated with the first service provider 171a (e.g. A Donut Shop), the processor 120 may classify the first consumer review as a business vertical of “dessert bakery”, a topic of “taste”, and a language of “English”. As another example, if a fifth consumer review states “Semoga murah rezeki” in Bahasa (e.g. its actual meaning does not relate to price, but relates to a blessing, due to the word of “rezeki”) and the fifth consumer review is associated with the first service provider 171a (e.g. A Donut Shop), the processor 120 may classify the fifth consumer review as a business vertical of “dessert bakery”, a topic of “irrelevant” (because the fifth consumer review relates to blessing), and a language of “Bahasa”.

In some embodiments, the processor 120 may distribute the task for the annotation associated with the selected consumer review to at least one of the one or more computing devices 180 associated with the one or more third parties 181 based on the classification of the selected consumer review. In some embodiments, the third parties 181, for example, agents and/or internal employees, may sign up for an annotation program via an internal device application and subscribe categories and languages of consumer reviews they are comfortable to give accurate annotation. The processor 120 may push consumer reviews based on frequency requested by the third parties 181, and the third parties 181 may input their answers (e.g. annotation) on the consumer reviews via the device application. The processor 120 may use the third parties'181 answers for modelling. In this manner, a third party who is relevant to the classification may be assigned the task for the annotation. For example, if a first third party 181a is relevant to a business vertical of “dessert bakery”, a topic of “taste”, and a language of “English”, the first third party 181a may be assigned the task for the annotation for the first consumer review. As another example, if a second third party 181b is relevant to a business vertical of “dessert bakery”, a topic of “price”, and a language of “Bahasa”, the second third party 181b may be assigned the task for the annotation for the fifth consumer review. Although not shown, in some embodiments, a plurality of third parties who are relevant to the classification may be assigned the task for the annotation for the same consumer review.

In some embodiments, the processor 120 may communicate with a server operating the predetermined software application via the communication interface 110. In some embodiments, the processor 120 may send a request to distribute the task for the annotation associated with the selected consumer review, to the server operating the predetermined software application, and the server operating the predetermined software application may distribute the task for the annotation to the at least one of the one or more computing devices 180 associated with the one or more third parties 181 based on the classification of the selected consumer review. For example, the processor 120 may send the request to distribute the task for the annotation for the first consumer review and information about the classification of the first consumer review to the server operating the predetermined software application. The server operating the predetermined software application may then select a third party, for example, the first third party 181a, who will perform the task for the annotation for the first consumer review based on the classification of the first consumer review and each third parties' relevance to the classification, and distribute the task for the annotation for the first consumer review to the first computing device 180a associated with the first third party 181a.

In some other embodiments, the processor 120 may select a third party who will perform the task for the annotation associated with the selected consumer review, and send a request to distribute the task for the annotation associated with the selected consumer review to the selected third party, to the server operating the predetermined software application. The server operating the predetermined software application may distribute the task for the annotation to the selected third party, according to the processor's 120 request. For example, the processor 120 may select the first third party 181a who will perform the task for the annotation for the first consumer review, and send the request to distribute the task for the annotation for the first consumer review to the first third party 181a, to the server operating the predetermined software application. The server operating the predetermined software application may distribute the task for the annotation to the first third party 181a.

In some embodiments, the processor 120 may obtain an annotation associated with the selected consumer review from the one or more computing devices 180 associated with the one or more third parties 181. In some embodiments, the server operating the predetermined software application may receive the annotation from the assigned third party. For example, the server operating the predetermined software application may receive the annotation for the first consumer review from the computing device 180a associated with the first third party 181a. In some embodiments, at least one of a language of the consumer review, a category of the consumer review, and one or more short phrases summarized from the consumer review may be an annotation which may be used as a recommendation tag for the service provider. For example, the annotation on the language may be needed in case a language detector is wrong. For example, a sixth consumer review states “It is my second time ordering from here. Loved the oat milk latte and the cake taste delicious as well! Look forward to more vegan options and more deals.” As an example, the annotation for the sixth consumer review may be as follows:
·Language: English
·Category: Taste
Short Phrases: 1. Loved the oat milk latte. 2. Delicious cake or cake taste delicious

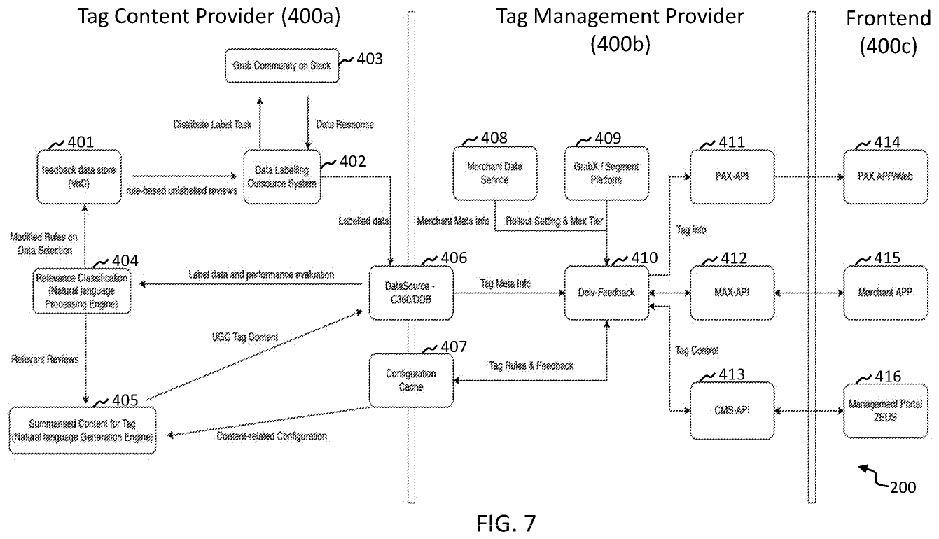

As described above, the processor 120 may dispatch the task for the annotation based on, for example, the business vertical, the topic, and the language, via the predetermined software application. In addition, the processor 120 may use a multilingual corpus (e.g. Southeast Asian multilingual corpus) which may contextualize a meaning of a token in a sentence included in the consumer reviews, which may be difficult to be accurately translated or learnt solid contextual relationship with other tokens in the same sentence, especially when the sentence is short. For example, if the fifth consumer review states “Semoga murah rezeki” in Bahasa, the fifth consumer review may be incorrectly decided to be relevant to the category of “price” due to mistranslating “rezeki” (e.g. its meaning is “sustenance”) as “price”, for example, with negative sentiment by a feedback data store 401 (as will be described with reference to FIG. 7). However, in reality, the fifth consumer review means a “blessing”. The multilingual corpus may detect that the fifth consumer review means the “blessing” which is not relevant to the category of “price”, and further improve the accuracy of the processor 120.

In some embodiments, the processor 120 may generate a tag content associated with the selected consumer review by summarizing the selected consumer review. In some embodiments, the processor 120 may include a natural language generation engine configured to summaries the contents of the selected consumer review and generate the tag content. In some embodiments, the processor 120 may include a tag configuration cache 407 (as will be described with reference to FIG. 7) configured to store at least one constraint (also referred to as “configuration(s)”) for generating the tag content which may fit into a tag to be displayed on service provider cards. For example, the at least one constraint may include, but is not limited to, content freshness, a maximum word count or a length, and a language. In some embodiments, the processor 120 may generate the tag content associated with the selected consumer review based on the at least one constraint stored in the tag configuration cache 407. For example, if the first consumer review states “I was very satisfied with the taste of the food”, the processor 120 may generate the tag content of “nice taste” by summarizing the content of the first consumer review of “I was very satisfied with the taste of the food”. As an example, the processor 120 may check the constraint for generating the tag content, for example, if the language is English and the maximum word count of the tag content does not exceed a predetermined number. If the generated tag content does not comply with the constraint, the processor 120 may revise the generated tag content to comply with the constraint.

In some embodiments, the processor 120 may generate a tag associated with the selected consumer review based on the tag content and the annotation associated with the selected consumer review. In some embodiments, the processor 120 may check if the tag content satisfies with the constraint stored in the tag configuration cache 407, for example, the content freshness, the maximum word count or the length, and the language, and generate the tag associated with the selected consumer review if the tag content satisfies with the at least one constraint. In some embodiments, the processor 120 may generate the tag associated with the selected consumer review further based on search keywords input by a plurality of consumers. For example, RNN (recurrent neural network) model may be used to incorporate information of the search keywords input by the plurality of consumers, to generate the tag or tip associated with the service provider that is mostly relevant to the search keywords.

In some embodiments, the processor 120 may display the generated tag associated with the selected consumer review along with information about the service provider included in a list of service providers. For example, the processor 120 may generate the tag based on the tag content of “nice taste” and the received annotation, to display on the computing device 160 of the user 161 who set the language of the platform as English and is looking for dessert. The processor 120 may then display the generated tag of “nice taste” on the first service provider card in the list of service providers.

In some embodiments, the selected consumer review may be relevant to two or more categories. The processor 120 may determine that the selected consumer review is relevant to two or more predetermined categories. For example, if the fourth consumer review states “I was very satisfied with the taste of the food and the reasonable price”, the processor 120 may select the fourth consumer review which is relevant to the category of “taste” and the category of “price”. In some embodiments, the processor 120 may extract two or more phrases each relevant to the two or more categories from the selected consumer review using the natural language processing model. For example, the processor 120 may extract phrases of “I was very satisfied with the taste of the food” relevant to the category of “taste” and “I was very satisfied with the reasonable price” relevant to the category of “price”, from the fourth consumer review. As an example, the processor 120 may use a tokenizer (e.g. a BERT tokenizer). In some embodiments, the processor 120 may generate two or more tag contents each associated with the two or more phrases. For example, the processor 120 may generate tag contents of “nice taste” and “reasonable price” from the extracted phrases respectively. In some embodiments, the processor 120 may generate the tag based on the two tag contents and the received annotation.

In some embodiments, the processor 120 may update a rule for selecting the at least one of the consumer reviews which is relevant to the at least one predetermined category, based on the annotation obtained from the one or more computing devices 180 associated with the one or more third parties 181. In some embodiments, the processor 120 may select the at least one of the consumer reviews which is relevant to the at least one predetermined category based on the rule (also referred to as a “predetermined rule”). After receiving the annotation from the server operating the predetermined software application, the processor 120 may update the predetermined rule based on the annotation, to improve the predetermined rule. In other words, the annotation may be used as an input to train the processor 120 to update the predetermined rule.

In some embodiments, the processor 120 may monitor the user's 161 behaviour for tags displayed on the computing device 160 and/or at least one consumer review previously made by the user 161. The processor 120 may determine which tag of a plurality of tags is to be displayed on the computing device 160 based on the monitored information. For example, if the processor 120 may determine that the user 161 is interested in price, rather than taste, the processor 120 may display tags relevant to the price on the computing device 160.

In some embodiments, the processor 120 may determine a weight for each of the plurality of tag, based on the monitored information. For example, if the processor 120 may determine that the user 161 is interested in price, rather than taste, the processor 120 may assign a higher weight to tags relevant to the price, and a lower weight to tags relevant to other categories, for example, taste, service, etc.

FIG. 4 illustrates a flow diagram for a method 300 for processing consumer reviews according to various embodiments.

According to various embodiments, the method 300 for processing the consumer reviews may be provided.

In some embodiments, the method 300 may include a step 301 of accessing the consumer reviews associated with a service provider.

In some embodiments, the method 300 may include a step 302 of selecting at least one of the consumer reviews which is relevant to at least one predetermined category.

In some embodiments, the method 300 may include a step 303 of classifying the selected consumer review based on at least one property of the selected consumer review.

In some embodiments, the method 300 may include a step 304 of distributing a task for an annotation associated with the selected consumer review to a computing device associated with a third party based on the classification of the selected consumer review.

In some embodiments, the method 300 may include a step 305 of obtaining the annotation associated with the selected consumer review from the computing device associated with the third party.

In some embodiments, the method 300 may include a step 306 of generating a tag content associated with the selected consumer review by summarizing the selected consumer review.

In some embodiments, the method 300 may include a step 307 of generating a tag associated with the selected consumer review based on the tag content and the annotation associated with the selected consumer review.

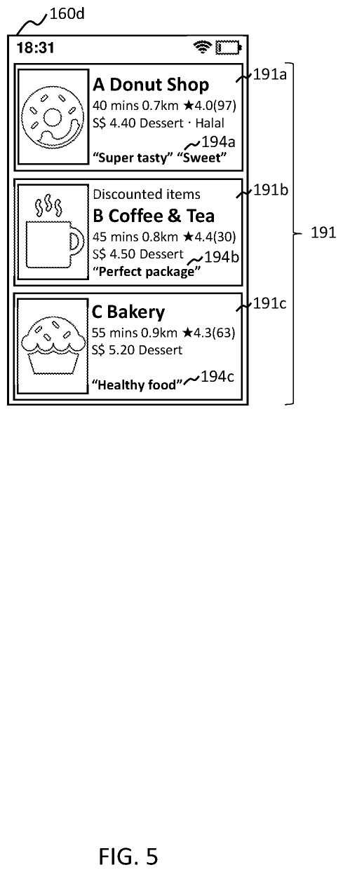

FIG. 5 illustrates an exemplary user interface screen 160d of a computing device 160 associated with a user 161 according to various embodiments.

As shown in FIG. 5, the computing device 160 associated with the user 161 may display the user interface screen 160d for the user 161 to make a request for an on-demand service. The user interface screen 160d may show a list of service providers 191. Information about the service providers may be displayed on service provider cards 191a, 191b, 191c in the list of service providers 191. For example, each service provider card 191a, 191b, 191c may show at least one of promotion information, a type of the service provider, performance of the service provider, an estimated time of arrival (“ETA”), ratings, and information about items provided by the service provider.

In addition, as shown in FIG. 5, each service provider card 191a, 191b, 191c may show tags 194 associated with a corresponding service provider. For example, a first service provider card 191a associated with a first service provider (e.g. A Donut Shop) may show tags 194a generated based on consumer reviews for the first service provider. As an example, a second service provider card 191b associated with a second service provider (e.g. B Coffee & Tea) may show tags 194b generated based on consumer reviews for the second service provider. As an example, a third service provider card 191c associated with a third service provider (e.g. C Bakery) may show tags 194c generated based on consumer reviews for the third service provider.

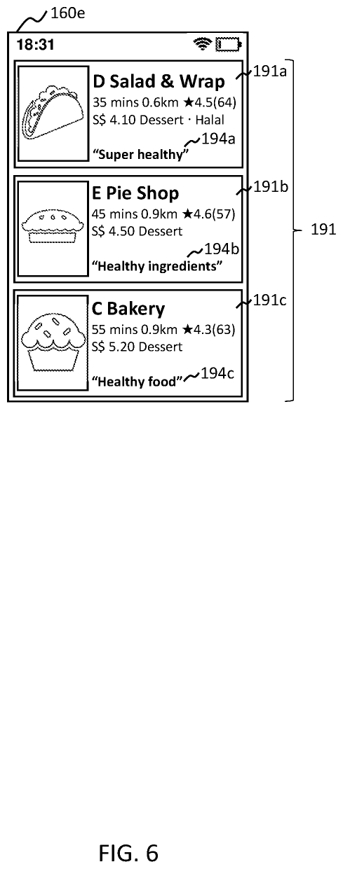

FIG. 6 illustrates an exemplary user interface screen 160e of a computing device 160 associated with a user 161 according to various embodiments.

In some embodiments, a processor 120 of a server 100 may monitor the user's 161 behaviour for tags displayed on the computing device 160 and/or at least one consumer review previously made by the user 161. The processor 120 may determine which tag of a plurality of tags is to be displayed on the computing device 160 based on the monitored information (as described with reference to FIG. 3).

In this manner, as shown in FIG. 6, tags 194 displayed on service provider cards 191a, 191b, 191c may be relevant to the user's 161 interest. For example, if the processor 120 determines that the user 161 is interested in healthy food based on the monitored information, the processor 120 may select tags relevant to “healthy food”, and display the selected tags on the service provider cards 191a, 191b, 191c.

FIG. 7 illustrates a block diagram of a system 200 for processing consumer reviews according to various embodiments.

As shown in FIG. 7, the system 200 may include a tag content provider 400a, a tag management provider 400b, and a frontend 400c.

In some embodiments, a feedback data store (VoC (Voice of Consumer)) 401 may be a raw data source of consumer reviews. In some embodiments, the feedback data store 401 may store metadata of the consumer reviews, and apply high-level classification on a business vertical, a topic, and/or a language. In some embodiments, the feedback data store 401 may store data on a daily basis.

In some embodiments, a data labelling outsourcing system 402 may use a predetermined software application (e.g. a Slack application) 403. In some embodiments, a server operating the predetermined software application 403 may connect to a server operating a predetermined web application (e.g. Azure web application) and a predetermined database (e.g. SQL database) which may refresh and query data based on filters and/or rules on the business vertical, the topic, and/or the language received from the feedback data store 401. In some embodiments, the server operating the predetermined software application 403 may directly communicate with third parties (e.g. users of the Slack application) to distribute data labelling tasks (also referred to as a “task for annotation”) for the consumer reviews and receive results (also referred to as a “response”) (e.g. including the annotation) from the third parties. In some embodiments, the server operating the predetermined web application may handle the request for the data labelling tasks and the results received from the third parties. In some embodiments, the predetermined database may store the results received from the third parties. In some embodiments, the predetermined database may further store subscription data of the third parties including, but not limited to, a country, a native language, and a contribution frequency.

In some embodiments, a relevance classification engine 404 may be a service driven by a natural language processing model. In some embodiments, the relevance classification engine 404 may precisely identify whether the consumer reviews are relevant to a service provider, for example, price, taste, safety, packaging and/or service of the service provider, and send the relevant consumer reviews to a downstream service. In some embodiments, a training dataset of the natural language processing model may come from the data labelling outsourcing system 402. In some embodiments, a prediction outcome of the service may be fed back into the feedback data store 401, so that the feedback data store 401 may select the raw data more efficiently for the data labelling tasks based on improved data filtering rules. In some embodiments, the data labelling outsourcing system 402 may read the raw data selected from the feedback data store 401.

In some embodiments, a summarized content engine 405 may be a service driven by a natural language generation model which may consume the relevant consumer reviews received from the relevance classification engine 404 and specific constraints on outcome contents received from a tag configuration cache 407. In some embodiments, the summarized content engine 405 may generate the summarized content (also referred to as a “tag content”) and send the summarized content to a data source 406 which may fit into a tag on a service provider card.

In some embodiments, the tag management provider 400b may perform a step of “tag creation”, a step of “tag management”, and a step of “tag display”. In some embodiments, the tag management provider 400b may create and update new tags with summarized tag content allowing flexibility in configurations and manual intervention such as the content freshness, the maximum word count or the length, and the language.

In some embodiments, in the step of “tag creation”, a delv-feedback system (delivery-feedback system) 410 may be used. In some embodiments, the delv-feedback system 410 may be configured to centralize multiple tag management requests including creation, update, deletion, storage, and validation based on rules. In some embodiments, the delv-feedback system 410 may consume the tag content and related settings received from the data source 406 and other platforms (e.g. GrabX and SegP), and double-check if the tag content satisfies the constraints (also referred to as “configurations”) including, but not limited to, content freshness, a maximum word count or a length, and a language. In some embodiments, if a service provider may be enabled with a UGC-based (user-generated content based) service provider tag feature, the delv-feedback system 410 may create the tag for the service provider, ready for the downstream service.

In some embodiments, in the step of “tag management”, content settings for tags for a specific location (e.g. a specific city) or service providers may be defined. For example, the content settings may be defined by an operator of a platform operating a server 100. In some embodiments, flexibility in the configurations on the content freshness time period, the maximum word count or the length, and the language may be allowed. In some embodiments, the rules may be stored in the tag configuration cache 407 for both the tag content provider 400a and the tag management provider 400b.

In some embodiments, in the step of “tag display”, the delv-feedback system 410 may send tags to the frontend 400c. In some embodiments, the service providers may approve or reject their tags before showing up, and feedback of the service providers may be recorded for engine optimization. In some embodiments, a notification frequency and a batch size of the tags for verification may be configurable. In some embodiments, the operator of the platform operating the server 100 may check tag logs and manually modify the tags (e.g. via Zeus). Thereafter, the consumers may view the tags generated based on the consumer reviews, as shown in FIGS. 5 and 6.

In some embodiments, an automated analytics engine (not shown) may provide prior information about preferences and transaction behaviours of the consumers. For example, consumers detected as “value seeker” may be more likely to see the tags under the category of “price”. In some embodiments, the automated analytics engine may evaluate pre-post performance, for example, via Bayesian Structural Time Series model (BSTS), and significant tests for decision making, such as taking down tags which may cause low or even negative impact. For example, the automated analytics engine may evaluate financial impact after the tags are released, to decide personalized actions on the displayed tags. In some embodiments, the automated analytics engine may fine-tune weights for each tag and/or shape the consumers' demand.

As described above, according to various embodiments, the system 200 including the server 100 may help promote the growth of service providers having long-tail strategies and gain consumers'interest and trust towards unfamiliar service providers by:
The annotation outsourcing system and the multilingual corpus (e.g. Southeast Asian multilingual corpus) collected from a chatbot of the predetermined software application (e.g. a Slack chatbot) and the feedback associated with the service providers triggered by the predetermined software application.
Filtering and summarizing relevant consumer reviews via multiple stages of text data processing:
A data product (Voice of Consumers) implemented in the server 100 may run the first round of filtering and embedding clustering to select the consumer reviews relevant to, for example, price, taste, safety, packaging and/or service of the service provider.
The natural language processing engine (e.g. with distilBERT and GPT-2 model) may run classification to further filter the consumer reviews for outsourcing the task for the annotation and generate multiple concise tags commenting different facets about the service provider.
The automatic merchant tag management system to create and update new tags with summarized tag content allowing flexibility in configurations and manual intervention such as the content freshness time period, the maximum word count or the length, and the language.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A server for processing consumer reviews, the server comprising:
a memory for storing instructions; and
a processor for executing the stored instructions and configured to:
access the consumer reviews associated with a service provider;
select at least one of the consumer reviews which is relevant to at least one predetermined category;
obtain an annotation associated with the selected consumer review from a computing device associated with a third party;
generate a tag content associated with the selected consumer review by summarizing the selected consumer review; and
generate a tag associated with the selected consumer review based on the tag content and the annotation associated with the selected consumer review,
wherein the processor is further configured to classify the selected consumer review based on at least one property of the selected consumer review, and distribute a task for the annotation associated with the selected consumer review to the computing device associated with the third party based on the classification of the selected consumer review.

2. The server according to claim 1, wherein the processor is further configured to update a rule for selecting the at least one of the consumer reviews which is relevant to the at least one predetermined category, based on the annotation obtained from the computing device associated with the third party.

3. The server according to claim 1, wherein the processor is configured to generate the tag content associated with the selected consumer review based on at least one constraint stored in a tag configuration cache.

4. The server according to claim 3, wherein the processor is further configured to check if the tag content satisfies with the at least one constraint stored in the tag configuration cache, and generate the tag associated with the selected consumer review if the tag content satisfies with the at least one constraint.

5. The server according to claim 3, wherein the processor is configured to generate the tag associated with the selected consumer review further based on search keywords input by a plurality of consumers.

6. The server according to claim 1, wherein the processor is further configured to determine that the selected consumer review is relevant to two or more categories, and extract two or more phrases each relevant to the two or more categories from the selected consumer review using a natural language processing model.

7. The server according to claim 6, wherein the processor is further configured to generate two or more tag contents each associated with the two or more phrases.

8. The server according to claim 1, wherein the processor is further configured to display the tag associated with the selected consumer review along with information about the service provider included in a list of service providers.

9. The server according to claim 1, wherein the processor is further configured to monitor a user's behaviour for tags displayed on a computing device associated with the user and/or at least one consumer review previously made by the user, and determine which tag of a plurality of tags is to be displayed on the computing device associated with the user based on the monitored information.

10. The server according to claim 9, wherein the processor is further configured to determine a weight for each of the plurality of tag, based on the monitored information.

11. A method for processing consumer reviews, the method comprising:
accessing the consumer reviews associated with a service provider;
selecting at least one of the consumer reviews which is relevant to at least one predetermined category;
classifying the selected consumer review based on at least one property of the selected consumer review;
distributing a task for an annotation associated with the selected consumer review to a computing device associated with a third party based on the classification of the selected consumer review;
obtaining the annotation associated with the selected consumer review from the computing device associated with the third party;
generating a tag content associated with the selected consumer review by summarizing the selected consumer review; and
generating a tag associated with the selected consumer review based on the tag content and the annotation associated with the selected consumer review.

12. The method according to claim 11 further comprising: updating a rule for selecting the at least one of the consumer reviews which is relevant to the at least one predetermined category, based on the annotation obtained from the computing device associated with the third party.

13. The method according to claim 11, wherein the generating the tag content associated with the selected consumer review is based on at least one constraint stored in a tag configuration cache.

14. The method according to claim 13 further comprising:
checking if the tag content satisfies with the at least one constraint stored in the tag configuration cache; and
generating the tag associated with the selected consumer review if the tag content satisfies with the at least one constraint.

15. The method according to claim 13, wherein the generating the tag associated with the selected consumer review is further based on search keywords input by a plurality of consumers.

16. The method according to claim 11 further comprising:
determining that the selected consumer review is relevant to two or more categories; and
extracting two or more phrases each relevant to the two or more categories from the selected consumer review using a natural language processing model.

17. The method according to claim 16 further comprising: generating two or more tag contents each associated with the two or more phrases.

18. The method according to claim 11 further comprising: displaying the tag associated with the selected consumer review along with information about the service provider included in a list of service providers.

19. The method according to claim 11 further comprising:
monitoring a user's behaviour for tags displayed on a computing device associated with the user and/or at least one consumer review previously made by the user; and
determining which tag of a plurality of tags is to be displayed on the computing device associated with the user based on the monitored information.

20. The method according to claim 19 further comprising: determining a weight for each of the plurality of tag, based on the monitored information.
